(19) United States
(12) Patent Application Publication
(10) Pub. No.: US 2024/0308869 A1
(43) Pub. Date: Sep. 19, 2024

(54) METHOD FOR PREPARING VANADIUM BATTERY ELECTROLYTE BY DISSOLVING WASTE VANADIUM CATALYST WITH SULFURIC ACID

(71) Applicant: Hunan Shanfeng Vanadium Industry Co., Ltd., Changsha City (CN)

(72) Inventors: Xiaodi Xu, Changsha City (CN); Dingjun Guo, Changsha City (CN)

(21) Appl. No.: 18/209,197

(22) Filed: Jun. 13, 2023

(30) Foreign Application Priority Data
Mar. 15, 2023 (CN) 2023102457415

(51) Int. Cl. C01G 31/00; C22B 3/22; C22B 3/44; C22B 7/00; H01M 10/54

(52) U.S. Cl. CPC C01G 31/006; C22B 3/22; C22B 3/44; C22B 7/007; H01M 10/54

(57) ABSTRACT

The present disclosure belongs to the technical field of recovery and reuse of waste vanadium catalysts, and in particular relates to a method for preparing a vanadium battery electrolyte by dissolving a waste vanadium catalyst with sulfuric acid. In the present disclosure, the method includes the following steps: immersing the waste vanadium catalyst in dilute sulfuric acid, and conducting leaching by heating to obtain a vanadium leaching masterbatch; where the dilute sulfuric acid has a mass percentage of less than or equal to 25%, and the leaching by heating is conducted for less than or equal to 2 h; and mixing the vanadium leaching masterbatch with an oxalic acid solution, conducting reduction by heating, and subjecting an obtained reduced masterbatch to solid-liquid separation to obtain the vanadium battery electrolyte; where the vanadium battery electrolyte is a vanadyl sulfate solution.

### CROSS REFERENCE TO RELATED APPLICATION

This patent application claims the benefit and priority of Chinese Patent Application No. 2023102457415, filed with the China National Intellectual Property Administration on Mar. 15, 2023, the disclosure of which is incorporated by reference herein in its entirety as part of the present application.

### TECHNICAL FIELD

The present disclosure belongs to the technical field of recovery and reuse of waste vanadium catalysts, and in particular relates to a method for preparing a vanadium battery electrolyte by dissolving a waste vanadium catalyst with sulfuric acid.

### BACKGROUND

At present, in the manufacture of sulfuric acid, fertilizer, gas, natural gas, petrochemical and other industries, a large amount of vanadium catalyst is required for catalysis, desulfuration, denitrification, or decarbonization. According to incomplete statistics, the vanadium catalyst used throughout the year ranges from 22,000 tons to 25,000 tons, and is on the rise annually. However, in the process of using the vanadium catalyst, the original vanadium catalyst is made of vanadium pentoxide (V₂O₅). In the process of using the vanadium catalyst, the pentavalent vanadium is gradually reduced to the tetravalent vanadium. When a catalytic activity of the V₂O₅ is lower than 4.5%, the vanadium catalyst fails. In order to meet the technical requirements of a device in a catalytic reaction, the vanadium catalyst must be frequently switched. Although there are related methods for recycling replaced waste vanadium catalysts, these methods show an unsatisfactory recovery effect. When the waste vanadium catalyst is dried at 100° C. under constant humidity, harmful gases may be emitted: and when the waste vanadium catalyst is crushed. a large amount of toxic dust can damage people's health. After the waste vanadium catalyst is immersed by acid, wastewater and washing water have not been effectively centralized and recovered, and wastes in the process of recycling the waste vanadium catalyst cannot be digested.

In summary, conventionally, from the treatment and recovery of the waste vanadium catalyst and the production process of the vanadium electrolyte from the waste vanadium catalyst, pollutants are discharged into the environment, and easily pollute the environment.

Chinese patent CN108878944A disclosed a method for preparing a vanadium battery electrolyte from a waste vanadium catalyst, including step A: immersing the waste vanadium catalyst in an oxalic acid solution for 2 h to 8 h to form a vanadyl oxalate-containing solution: and treating the vanadyl oxalate-containing solution to obtain a vanadyl oxalate mother liquor.

However, this method needs to consume a large amount of expensive oxalic acid and has a long dissolution time. Accordingly, from an economic point of view, this method is not conducive to enterprise production.

### SUMMARY

An objective of the present disclosure is to provide a method for preparing a vanadium battery electrolyte by dissolving a waste vanadium catalyst with sulfuric acid. In this method, the waste vanadium catalyst is dissolved with a sulfuric acid solution. Compared with oxalic acid, the dissolution time required for the sulfuric acid solution to dissolve the waste vanadium catalyst is greatly reduced, thereby effectively improving a production efficiency of the vanadium battery electrolyte. Meanwhile, the cost of sulfuric acid dissolution is lower than that of oxalic acid dissolution, thus effectively saving a production cost in preparing the vanadium battery electrolyte by recycling the waste vanadium catalyst. In this way, the economic benefits of the enterprises is improved by this method.

To achieve the above objective, the present disclosure provides the following technical solutions:

The present disclosure provides a method for preparing a vanadium battery electrolyte by dissolving a waste vanadium catalyst with sulfuric acid, including the following steps:

immersing the waste vanadium catalyst in dilute sulfuric acid, and conducting leaching by heating to obtain a vanadium leaching masterbatch: where the dilute sulfuric acid has a mass percentage of less than or equal to 25%, and the leaching by heating is conducted for less than or equal to 2 h: and the vanadium leaching masterbatch includes tetravalent vanadium ions and pentavalent vanadium ions: and

mixing the vanadium leaching masterbatch with an oxalic acid solution, conducting reduction by heating, and subjecting an obtained reduced masterbatch to solid-liquid separation to obtain the vanadium battery electrolyte: where the vanadium battery electrolyte is a vanadyl sulfate solution.

Preferably, the diluted sulfuric acid has a mass percentage of 15% to 25%.

Preferably, the leaching by heating is conducted for 1 h to 2 h.

Preferably, the leaching by heating is conducted at 80° C. to 90° C.

Preferably, the oxalic acid solution has the same molar concentration as that of the pentavalent vanadium ions in the vanadium leaching masterbatch.

Preferably, the reduction is conducted at 80° C. to 90° C. for 1 h.

Preferably, a waste vanadium catalyst wet slag is further obtained by the solid-liquid separation: after the solid-liquid separation is completed, the method further includes a post-treatment on the waste vanadium catalyst wet slag: and the post-treatment includes the following steps: collecting a residual vanadium battery electrolyte on a surface of the waste vanadium catalyst wet slag, and combining the residual vanadium battery electrolyte with the vanadium battery electrolyte; washing the waste vanadium catalyst wet slag after raffinate collection with water, and using an obtained washed solution as a dilution solvent of the dilute sulfuric acid.

Preferably, after the solid-liquid separation is completed, the method further includes conducting concentration on the vanadium battery electrolyte to obtain a vanadium battery electrolytic concentrate: and the vanadium battery electrolytic concentrate has the tetravalent vanadium ions at a concentration of 1.5 mol/L to 2.2 mol/L.

Preferably, the vanadium battery electrolytic concentrate has a stack discharge efficiency of 75% to 85%.

Preferably, after the solid-liquid separation is completed, the method further includes conducting concentration on the vanadium battery electrolyte to dryness to obtain a crystalline vanadyl sulfate solid product.

The present disclosure provides a method for preparing a vanadium battery electrolyte by dissolving a waste vanadium catalyst with sulfuric acid, including the following steps: immersing the waste vanadium catalyst in dilute sulfuric acid, and conducting leaching by heating to obtain a vanadium leaching masterbatch: where the dilute sulfuric acid has a mass percentage of less than or equal to 25%, and the leaching by heating is conducted for less than or equal to 2 h: and the vanadium leaching masterbatch includes tetravalent vanadium ions and pentavalent vanadium ions: and mixing the vanadium leaching masterbatch with an oxalic acid solution, conducting reduction by heating, and subjecting an obtained reduced masterbatch to solid-liquid separation to obtain the vanadium battery electrolyte: where the vanadium battery electrolyte is a vanadyl sulfate solution. In this method, the waste vanadium catalyst is dissolved with a sulfuric acid solution. Compared with oxalic acid, the dissolution time required for the sulfuric acid solution to dissolve the waste vanadium catalyst is greatly reduced, thereby effectively improving a production efficiency of the vanadium battery electrolyte. Meanwhile, the cost of sulfuric acid dissolution is lower than that of oxalic acid dissolution, thus effectively saving a production cost in preparing the vanadium battery electrolyte by recycling the waste vanadium catalyst. In this way, the economic benefit of the enterprises is improved by this method. The results of the examples show that compared to the method disclosed in Chinese patent CN108878944A, the method for preparing a vanadium battery electrolyte by dissolving a waste vanadium catalyst with sulfuric acid has reduced the amount of oxalic acid by about 50%, and a production process of a single vanadium battery electrolyte saves time by 2 h to 6 h.

### DETAILED DESCRIPTION OF THE EMBODIMENTS

The present disclosure provides a method for preparing a vanadium battery electrolyte by dissolving a waste vanadium catalyst with sulfuric acid, including the following steps:

immersing the waste vanadium catalyst in dilute sulfuric acid, and conducting leaching by heating to obtain a vanadium leaching masterbatch: where the dilute sulfuric acid has a mass percentage of less than or equal to 25%, and the leaching by heating is conducted for less than or equal to 2 h: and the vanadium leaching masterbatch includes tetravalent vanadium ions and pentavalent vanadium ions: and

mixing the vanadium leaching masterbatch with an oxalic acid solution, conducting reduction by heating, and subjecting an obtained reduced masterbatch to solid-liquid separation to obtain the vanadium battery electrolyte: where the vanadium battery electrolyte is a vanadyl sulfate solution.

In the present disclosure, unless otherwise specified, all raw materials for preparation are commercially available products well known to those skilled in the art.

In the present disclosure, the waste vanadium catalyst is immersed in dilute sulfuric acid, and leaching by heating is conducted to obtain a vanadium leaching masterbatch; where the dilute sulfuric acid has a mass percentage of less than or equal to 25%, and the leaching by heating is conducted for less than or equal to 2 h: and the vanadium leaching masterbatch includes tetravalent vanadium ions and pentavalent vanadium ions.

In the present disclosure, there is no special requirement on a source of the waste vanadium catalyst, and the waste vanadium catalyst produced in the desulfurization, denitrification, or decarbonization of sulfuric acid manufacturing, chemical fertilizer manufacturing, gas manufacturing, natural gas manufacturing, or petrochemical industries can be used.

In the present disclosure, the dilute sulfuric acid has a mass percentage of preferably 15% to 25%, more preferably 18% to 21%.

In the present disclosure, the leaching by heating is conducted for preferably 1 h to 2 h, more preferably 1.2 h to 1.5 h.

In the present disclosure, the leaching by heating is conducted at 80° C. to 90° C., more preferably at 82° C. to 85° C.

In the present disclosure, during the leaching by heating, hydrogen ions in the sulfuric acid react with vanadium pentoxide and vanadium dioxide in the waste vanadium catalyst: in this way, pentavalent alum ions and tetravalent alum ions are dissolved in the sulfuric acid to obtain a vanadium leaching masterbatch.

In the present disclosure, dilute sulfuric acid is used to replace oxalic acid during the leaching by heating. Compared with that of oxalic acid, the dissolution time is greatly reduced, thereby effectively improving the production efficiency of the vanadium battery electrolyte. Meanwhile, the cost of sulfuric acid dissolution is lower than that of oxalic acid dissolution, thus effectively saving a production cost in preparing the vanadium battery electrolyte by recycling the waste vanadium catalyst. In this way, the economic benefit of the enterprises is improved by this method.

In the present disclosure, the vanadium leaching masterbatch is mixed with an oxalic acid solution, reduction is conducted by heating, and an obtained reduced masterbatch is subjected to solid-liquid separation to obtain the vanadium battery electrolyte: where the vanadium battery electrolyte is a vanadyl sulfate solution.

In the present disclosure, the oxalic acid solution has preferably a same molar concentration as that of the pentavalent vanadium ions in the vanadium leaching masterbatch.

In the present disclosure, the reduction is conducted preferably at 80° C. to 90° C., more preferably at 85° C. to 90° C. The reduction is conducted for preferably 1 h.

In the present invention, the solid-liquid separation is preferably conducted by filtration.

In the present disclosure, a waste vanadium catalyst wet slag is further obtained by the solid-liquid separation: after the solid-liquid separation is completed, the method further includes preferably a post-treatment on the waste vanadium catalyst wet slag: and the post-treatment includes preferably the following steps: collecting a residual vanadium battery electrolyte on a surface of the waste vanadium catalyst wet slag, and combining the residual vanadium battery electrolyte with the vanadium battery electrolyte: washing the waste vanadium catalyst wet slag after raffinate collection with water, and using an obtained washed solution as preferably a dilution solvent of the dilute sulfuric acid. The step of washing with water preferably refers to water rinsing or water immersion. As one or more examples, the water washing refers to the water immersion preferably 1 to 5 times. Preferably, the residual vanadium battery electrolyte on a surface of the waste vanadium catalyst wet slag is cleaned by washing with water, and the obtained washed solution is preferably used as a dilution solvent for the dilute sulfuric acid. This can further improve a vanadium recovery rate of the waste vanadium catalyst.

In the present disclosure, the vanadium recovery rate of the waste vanadium catalyst is 97% to 99%.

In the present disclosure, after the solid-liquid separation is completed, the method further includes preferably conducting concentration on the vanadium battery electrolyte to obtain a vanadium battery electrolytic concentrate. The vanadium battery electrolytic concentrate has the tetravalent vanadium ions at a concentration of preferably 1.5 mol/L to 2.2 mol/L.

In the present disclosure, the vanadium battery electrolytic concentrate has a stack discharge efficiency of preferably 75% to 85%.

In the present disclosure, after the solid-liquid separation is completed, the method further includes preferably conducting concentration on the vanadium battery electrolyte to dryness to obtain a crystalline solid vanadyl sulfate product.

In order to further illustrate the present disclosure, the technical solutions provided by the present disclosure are described in detail below in connection with examples, but these examples should not be understood as limiting the claimed scope of the present disclosure.

### Example 1

100 kg of a waste vanadium catalysts was heated to 90° C. in dilute sulfuric acid and immersed for 1 h to obtain a vanadium leaching masterbatch, where the dilute sulfuric acid had a mass concentration of 25%: and

4 kg to 5 kg of an oxalic acid solution with a same molar concentration as pentavalent vanadium ions in the vanadium leaching masterbatch was added as a reducing agent into the vanadium leaching masterbatch: an obtained mixture was heated to 90° C. and stirred for 1 h, such that pentavalent vanadium was reduced to tetravalent vanadium to obtain a reduced masterbatch.

The reduced masterbatch was filtered to obtain a vanadium battery electrolyte and a waste vanadium catalyst wet slag: a residual vanadium battery electrolyte on a surface of the waste vanadium catalyst wet slag was collected, and then combined with the vanadium battery electrolyte obtained by filtering to obtain a combined vanadium battery electrolyte: the waste vanadium catalyst wet slag after raffinate collection was immersed in water and washed 5 times to rinse remaining vanadyl sulfate (VOSO₄), and an obtained washed solution was used as a dilution solvent of the dilute sulfuric acid. The vanadium recovery rate of the vanadium catalyst was 99%.

The combined vanadium battery electrolyte was concentrated to obtain a vanadium electrolytic concentrate for preparing a vanadium battery. The vanadium ion concentration in the vanadium electrolytic concentrate was 1.5 mol/L to 2.2 mol/L, and a stack discharge efficiency of the vanadium electrolytic concentrate was 75% to 85%.

The vanadium battery electrolyte was concentrated to form crystals to prepare solid vanadyl sulfate or a solid vanadium battery.

### Comparative Example 1

Step A: a waste vanadium catalyst was immersed in an oxalic acid solution for 5 h, to generate a solution containing vanadyl oxalate, where the oxalic acid solution had a mass concentration of 20% to 50%, and the oxalic acid solution was formed by dissolving oxalic acid in water of 50° C. to 100° C.: 100 kg of the waste vanadium catalyst was immersed in 10 kg of the oxalic acid solution.

Step B: clean the waste vanadium catalyst, collect the vanadyl oxalate solution, use clear water to clean the soaked waste vanadium catalyst 1-5 times, and wash out the remaining vanadyl oxalate. The recovery rate of vanadium can reach 97%-99%, and the clear water washing solution can be used as the water for soaking next time.

Step C: a polyacid ester was added into the vanadyl oxalate solution: and after fully reacting, impurities were removed by filtration, and a filtrate was concentrated to obtain a vanadyl oxalate mother liquor: the waste vanadium catalyst was further added into the vanadyl oxalate mother liquor: and after a full reaction, a resulting solution was dried at 80° C. to 100° C. for 2 h to 3 h to obtain a waste vanadium catalyst powder. The waste vanadium catalyst powder was sent into a conversion furnace of 480° C. to 580° C. to conduct calcination for 2 h to 4 h, oxalic acid carbon was removed during calcination to make the waste vanadium catalyst form vanadium pentoxide, and the waste vanadium catalyst was oxidized to form a new vanadium catalyst.

Step D: a sulfuric acid solution was added into the vanadyl oxalate mother liquor, the mother liquor of vanadyl oxalate (VOC₂O₄) was cooled and then sulfuric acid which was 1 to 3 times the mass of the vanadyl oxalate was added, to generate a vanadyl sulfate solution (VOSO₄), which was filtered to obtain a vanadium electrolyte for preparing a vanadium battery. After the vanadium electrolyte was concentrated, the vanadium ion concentration in the vanadium electrolyte was 1.5 mol/L to 2.2 mol/L, and the stack discharge efficiency of the vanadium electrolyte was 75% to 85%. The vanadium electrolyte was concentrated and synthesized into a crystal to make solid vanadyl sulfate or make a solid vanadium battery.

In the present disclosure, by comparing Example 1 with Comparative Example 1, it was found that the amount of oxalic acid consumed in Example 1 was reduced by about 50%, and a production process of a single vanadium battery electrolyte saved the time by 2 h to 6 h.

### Example 2

100 kg of a waste vanadium catalysts was heated to 80° C. in dilute sulfuric acid and immersed for 1.5 h to obtain a vanadium leaching masterbatch, where the dilute sulfuric acid had a mass concentration of 15%; and

4 kg to 5 kg of an oxalic acid solution with a same molar concentration as pentavalent vanadium ions in the vanadium leaching masterbatch was added as a reducing agent into the vanadium leaching masterbatch: an obtained mixture was heated to 90° C. and stirred for 1 h, such that pentavalent vanadium was reduced to tetravalent vanadium to obtain a reduced masterbatch.

the reduced masterbatch was filtered to obtain a vanadium battery electrolyte and a waste vanadium catalyst wet slag: a residual vanadium battery electrolyte on a surface of the waste vanadium catalyst wet slag was collected, and then combined with the vanadium battery electrolyte obtained by filtering to obtain a combined vanadium battery electrolyte; the waste vanadium catalyst wet slag after raffinate collection was immersed in water and washed 5 times to rinse remaining vanadyl sulfate (VOSO₄), and an obtained washed solution was used as a dilution solvent of the dilute sulfuric acid. The vanadium recovery rate of the vanadium catalyst was 97%.

The combined vanadium battery electrolyte was concentrated to obtain a vanadium electrolytic concentrate for preparing a vanadium battery. The vanadium ion concentration in the vanadium electrolytic concentrate was 1.5 mol/L to 2.2 mol/L, and the stack discharge efficiency of the vanadium electrolytic concentrate was 75% to 85%.

The vanadium battery electrolyte was concentrated to form crystals to prepare solid vanadyl sulfate or a solid vanadium battery.

Although the present disclosure is described in detail in conjunction with the foregoing examples, they are only a part of, not all of, the examples of the present disclosure. Other examples can be obtained based on these examples without creative efforts, and all of these examples shall fall within the protection scope of the present disclosure.

What is claimed is:

1. A method for preparing a vanadium battery electrolyte by dissolving a waste vanadium catalyst with sulfuric acid, comprising the following steps:
immersing the waste vanadium catalyst in dilute sulfuric acid, and conducting leaching by heating to obtain a vanadium leaching masterbatch; wherein the dilute sulfuric acid has a mass percentage of less than or equal to 25%, and the leaching by heating is conducted for less than or equal to 2 h; and the vanadium leaching masterbatch comprises tetravalent vanadium ions and pentavalent vanadium ions: and
mixing the vanadium leaching masterbatch with an oxalic acid solution, conducting reduction by heating, and subjecting an obtained reduced masterbatch to solid-liquid separation to obtain the vanadium battery electrolyte: wherein the vanadium battery electrolyte is a vanadyl sulfate solution.

2. The method according to claim 1, wherein the dilute sulfuric acid has a mass percentage of 15% to 25%.

3. The method according to claim 1, wherein the leaching by heating is conducted for 1 h to 2 h.

4. The method according to claim 1, wherein the leaching by heating is conducted at 80° C. to 90° C.

5. The method according to claim 2, wherein the leaching by heating is conducted at 80° C. to 90° C.

6. The method according to claim 3, wherein the leaching by heating is conducted at 80° C. to 90° C.

7. The method according to claim 1, wherein the oxalic acid solution has a same molar concentration as that of the pentavalent vanadium ions in the vanadium leaching masterbatch.

8. The method according to claim 1, wherein the reduction is conducted at 80° C. to 90° C. for 1 h.

9. The method according to claim 7, wherein the reduction is conducted at 80° C. to 90° C. for 1 h.

10. The method according to claim 1, wherein a waste vanadium catalyst wet slag is further obtained by the solid-liquid separation; after the solid-liquid separation is completed, the method further comprises a post-treatment on the waste vanadium catalyst wet slag; and the post-treatment comprises the following steps: collecting a residual vanadium battery electrolyte on a surface of the waste vanadium catalyst wet slag, and combining the residual vanadium battery electrolyte with the vanadium battery electrolyte; washing the waste vanadium catalyst wet slag after raffinate collection with water, and using an obtained washed solution as a dilution solvent of the dilute sulfuric acid.

11. The method according to claim 1, wherein after the solid-liquid separation is completed, the method further comprises conducting concentration on the vanadium battery electrolyte to obtain a vanadium battery electrolytic concentrate; and the vanadium battery electrolytic concentrate has the tetravalent vanadium ions at a concentration of 1.5 mol/L to 2.2 mol/L.

12. The method according to claim 11, wherein the vanadium battery electrolytic concentrate has a stack discharge efficiency of 75% to 85%.

13. The method according to claim 1, wherein after the solid-liquid separation is completed, the method further comprises conducting concentration on the vanadium battery electrolyte to dryness to obtain a crystalline vanadyl sulfate solid product.
